(19) United States
(12) Patent Application Publication
(10) Pub. No.: US 2014/0368113 A1
(43) Pub. Date: Dec. 18, 2014

(54) Twin Aisle Light Architecture

(71) Applicant: B/E AEROSPACE, INC., Wellington, FL (US)

(72) Inventor: David P. Eckel, Fort Salonga, NY (US)

(21) Appl. No.: 13/919,799

(22) Filed: Jun. 17, 2013

(51) Int. Cl. B60Q 3/02

(52) U.S. Cl. CPC B60Q 3/0293
USPC 315/77

(57) ABSTRACT

A lighting system includes a base unit and a first modular light. The first modular light includes a first light unit, and a first lighting technology module. The first light unit includes a first light element that emits light, and a first mechanical, electrical, and control signal physical light unit interface that is removably coupled to a first mating light unit interface on the base unit. The first lighting technology module is physically separate from the first light unit and includes a first light driver that drives the first light element, a first light engine that is coupled to the first light driver, and a first mechanical, electrical, and control signal physical light technology module interface that is removably coupled to a first mating light technology module interface on the base unit.

### BACKGROUND

Disclosed herein is a lighting control architecture that provides flexibility in designing and modifying a lighting architecture for a vehicle lighting system.

In current lighting systems, the controller architecture relies heavily on rigid architectures that do not provide flexibility and the ability to easily interchange components. Each configuration must be qualified and certified separately, i.e., if a first configuration is different from a second configuration (e.g., having different components), the first and second configurations must be qualified and certified separately. There are no easy mechanisms in place for enabling and disabling the lighting technologies within the current lighting systems. Design changes are also more difficult to make once the vehicle is fitted with the current lighting systems.

### SUMMARY

The following acronyms are used herein:

### TABLE OF ACRONYMS

BIT built-in test
BITE built-in test equipment
CAN controller area network bus
bus
EIA/TIA Electronic Industries Alliance/Telecommunications Industry Associate
RS-485 Recommended Standard—485
FLED flexible light emitting diode
FO fiber optic
LED light emitting diode
LRU line replaceable unit
OLED organic light emitting diode
RAM random access memory
ROM read only memory
USB universal serial bus

It is desirable to provide a lighting control architecture that provides flexibility and adaptability for configuring a lighting system in a vehicle.

Disclosed herein is a lighting system that enables a multi-technology lighting architecture to be qualified and certified by, e.g., RTCA/DO-160, for installation and use in vehicles, such as aircraft, and permits new features to be enabled in the future, or by class, within the aircraft. The multi-technology lighting system includes a plurality of light units, and the plurality of light units may support many light applications, including general cabin lights, suite lights, galley lights, lavatory lights, and feature lights. Some of the light units, such as the feature lights, may be modular (i.e., modular feature lights). Each light unit may be pre-qualified and pre-certified before installation in the aircraft. The pre-qualification and pre-certification provide the option to mix and match different modular light units. Furthermore, plug-ins (either hardware or software modules) may be added and/or enabled locally at the light unit or remotely from a control panel, e.g., Cabin System Control Panel (CSCP) or Cabin Attendant Control Panel (CACP), via USB, Ethernet, etc.

Each modular feature light unit may include a light element, an optical element, and a lighting technology module. The light element is a light source that illuminates light and could be, e.g., LED, OLED, FLED, FO, remote phosphor light, fluorescent light bulbs, incandescent light bulb, etc. The optical element could be, e.g., lamp shades, lamp bodies, lenses, mirrors, etc. The lighting technology module includes a light driver and a light engine. The light driver includes hardware and/or software modules necessary to drive the light element to illuminate light. For example, the light driver could be a LED driver, OLED driver, FLED driver, FO driver, remote phosphor light driver, and any other light driver associated with any type of light element. The light engine includes various lighting technologies that may be used to enhance the lighting experience with the light element. For example, the light engine may include technology that changes the intensity of the light emitted by the light element, changes the color of the light emitted by the light element, allows the light element to be controlled by Wi-Fi or other wireless connections, etc. The various lighting technologies in the light engine may include hardware modules (e.g., microcontrollers, etc.), software modules, or both, that are required for the lighting technologies.

In an embodiment, a lighting system includes a base unit and a first modular light. The first modular light includes a first light unit and a first lighting technology module. The first light unit includes a first light element that emits light, and a first mechanical, electrical, and control signal physical light unit interface that is removably coupled to a first mating light unit interface on the base unit. The first lighting technology module is physically separate from the first light unit and includes a first light driver that drives the first light element, a first light engine that is coupled to the first light driver, and a first mechanical, electrical, and control signal physical light technology module interface that is removably coupled to a first mating light technology module interface on the base unit.

The first light element may include a light source selected from the group consisting of a light emitting diode (LED), a flexible LED, an organic light emitting diode (OLED), a fiber optic unit, a remote phosphor light, a fluorescent light bulb, and an incandescent light bulb.

The first mechanical, electrical, and control signal physical light unit interface may include a plug, and the first mating light unit interface may include a socket.

The first light unit may further include an optical element.

The first light driver may include a driver selected from the group consisting of a LED driver, a flexible LED driver, an OLED driver, a fiber optic unit driver, a remote phosphor light driver, a ballast, and a dimming switch.

The first light engine may include a module selected from the group consisting of a transceiver that receives a control signal from a passenger device, and a light intensity and color module that adjusts an intensity of light emitted by the first light element.

The first light engine may have a remote enable switch that is configured to be remotely enabled.

The first mechanical, electrical, and control signal physical light technology module interface may include a plug, and the first mating light technology module interface may include a socket.

The lighting system may further include a communication module that enables communication between the first lighting technology module and a remote controller, and a power converter that converts power used by the first modular light. The power converter may convert AC power to DC power.

The base unit and the first lighting technology module may be embedded in a wall of a vehicle.

In another embodiment, the lighting system may further include a second modular light. The second modular light includes a second light unit and a second lighting technology module. The second light unit includes a second light element that emits light, and a second mechanical, electrical, and control signal physical light unit interface that is removably coupled to a second mating light unit interface on the base unit. The second lighting technology module is physically separate from the second light unit and includes a second light driver that drives the second light element, a second light engine that is coupled to the second light driver, and a second mechanical, electrical, and control signal physical light technology module interface that is removably coupled to a second mating light technology module interface on the base unit. Furthermore, the first light unit may be interchangeable with the second light unit, and the first lighting technology module may be interchangeable with the second lighting technology module on the base unit.

The first modular light and the second modular light may be connected in series by a communication line and a power line, and the power line may receive excess power from a main power supply of a vehicle.

The lighting system may further include a power converter that is connected to the first modular light (direct connection or electrical connection with galvanic separation), where the first modular light and the power converter are isolated from the second modular light, and the power converter provides power to the second modular light.

The lighting system may further include a power supply that is separate from a main power supply of a vehicle, where the power supply provides power to the first modular light and the second modular light.

The lighting system may further include a router, a first communication line that connects the first modular light to the router, and a second communication line that connects the second modular light to the router. In an embodiment, the first and second communication lines may be EIA/TIA RS-485 (RS-485) network connections. In another embodiment, the first and second communication lines may be controller area network (CAN) bus lines.

The lighting system may further include a gateway that interfaces to two different protocols, a first communication line that connects the first modular light to the gateway, and a second communication line that connects the second modular light to the gateway. The first communication line may be a RS-485 network connections, and the second communication line may be a CAN bus line.

The first light element may be a type of light source that is different from the second light element.

The first modular light may further include a first token input and a first token output. The second modular light may further include a second token input and a second token output. The first token input may be either floating or set to a predetermined state, and the first token output may be connected to the second token input.

### BRIEF DESCRIPTION OF THE DRAWINGS

Features and advantages of this disclosure will become apparent by describing in detail exemplary embodiments with reference to the attached drawings in which:

FIG. 1A is a block diagram illustrating an exemplary lighting arrangement in a super first class setting;

FIG. 1B is a block diagram illustrating an exemplary lighting arrangement in a first class setting;

FIG. 1C is a block diagram illustrating an exemplary lighting arrangement in a business class setting;

FIG. 2 is a block diagram illustrating an exemplary modular light unit, according to an embodiment;

FIG. 3 is a block schematic diagram illustrating communications connections between a series of light units and their interface to a network through a gateway/router;

FIG. 4A is a block diagram illustrating an exemplary configuration of general cabin light units, according to an embodiment;

FIG. 4B is a block diagram illustrating another exemplary configuration of general cabin light units, according to another embodiment;

FIG. 4C is a block diagram illustrating an exemplary configuration of feature light units and general cabin light units, area/cove light units, or galley light units, according to an embodiment;

FIG. 5A is a block diagram illustrating one exemplary interconnecting of lighting components;

FIG. 5B is a block diagram illustrating another exemplary interconnecting of lighting components;

FIG. 5C is a block diagram illustrating a further exemplary interconnecting of lighting components;

FIG. 6A is a block diagram illustrating a modular light unit having five lighting technology modules;

FIG. 6B is a block diagram illustrating a modular light unit having four lighting technology modules;

FIG. 6C is a block diagram illustrating a modular light unit having three lighting technology modules;

FIG. 6D is a block diagram illustrating a modular light unit having two lighting technology modules; and

FIG. 6E is a block diagram illustrating a modular light unit having one lighting technology module.

### DETAILED DESCRIPTION

Exemplary embodiments will now be described more fully with reference to the accompanying drawings.

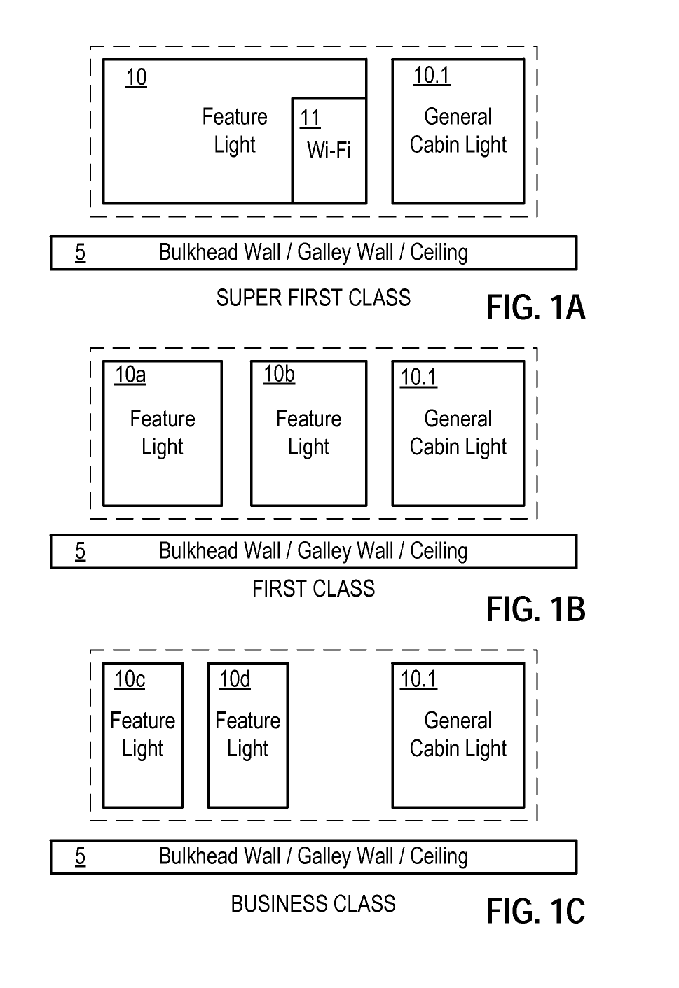

FIGS. 1A to 1C illustrate exemplary lighting configurations that differ according to class in an aircraft. In FIG. 1A, which illustrates an arrangement for super first class, a feature light unit 10 and a general cabin light unit 10.1 are located proximate an aircraft wall 5, such as a bulkhead wall, a galley wall, or aircraft ceiling. The general cabin light unit 10.1 includes ceiling lights, sidewall lights, galley lights, cove/area lights, and other lights necessary for the aircraft to meet various aviation requirements to take off. On the other hand, the feature light unit 10 includes extra/optional lights that are additional to the general cabin light unit 10.1. The feature light unit 10 is typically used to enhance the ambiance and atmosphere in the aircraft and may be used to distinguish between various classes within the aircraft. Since class distinction may be important in an aircraft design, the feature light unit 10 in the super first class section may incorporate all lighting technology existing in the first class section, and may include additional lighting technology that distinguishes it from the first class section. This configuration could use, e.g., organic light emitting diodes (OLEDs), and a Wi-Fi or other type of wireless connection 11 that can be connected to a passenger device (e.g., an iPhone or other mobile device). Through the Wi-Fi 11, a passenger can control the feature light unit 10 using the passenger device in the super first class section.

FIG. 1B illustrates an arrangement for first class, which includes the general cabin light unit 10.1 and separate feature light units 10a, 10b. The separate feature light units 10a, 10b in the first class section may be of lesser-enabled capability than the feature light unit 10 in the super first class section. “Lesser-enabled” means that a component could be installed but is not actually installed, or that the component is installed but is not enabled. For example, the Wi-Fi connection 11 of the feature light 10 may not be installed in the separate feature light units 10a, 10b. Alternatively, the Wi-Fi connection 11 is installed in the separate feature light units 10a, 10b, but is not enabled for use in the first class section. The separate feature light units 10a, 10b, by way of example, might incorporate light emitting diodes (LEDs), fiber optic units (FOs), flexible LEDs (FLED) (LEDs that utilizes a flexible printed circuit board), and remote phosphor wall lights.

FIG. 1C illustrates an arrangement for business class, which includes the general cabin light unit 10.1 and separate feature light units 10c, 10d. The separate feature light units 10c, 10d in the business class section that may incorporate, e.g., LEDs. Furthermore, the separate feature light units 10c and 10d in the business class section may have lesser-enabled capability than the separate feature light units 10a and 10b in the first class section in order to delineate the classes. All of the classes could be merged and made the same or different in support of leasing company needs via hardware or software plug-ins, enabling hidden mode or scenes in the LRU via loadable ops at the LRU or CSCP.

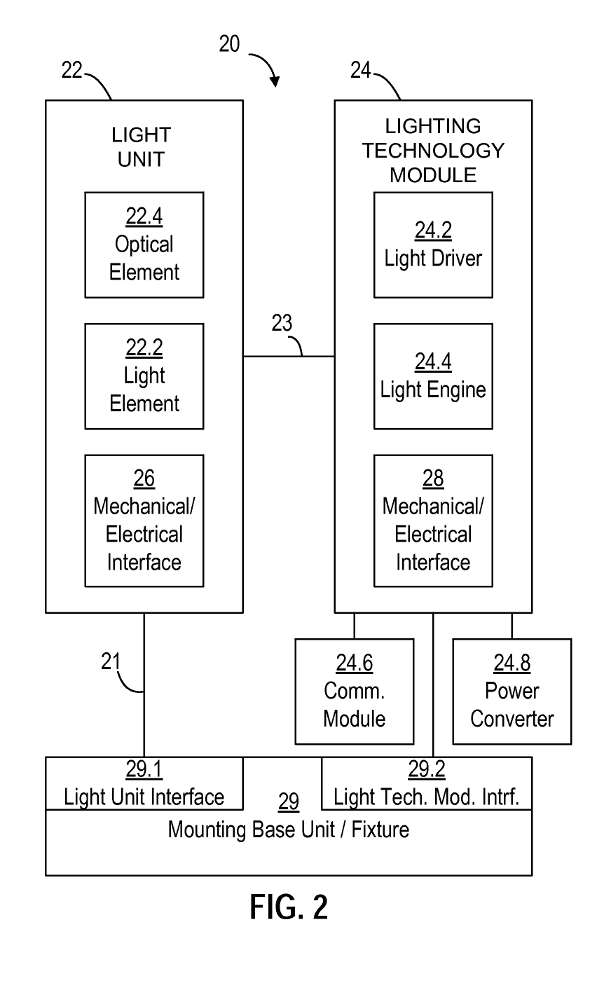

FIG. 2 illustrates an exemplary modular light 20, according to an embodiment. The modular light 20 may be the feature light unit 10 or the general cabin light unit 10.1 illustrated in FIGS. 1A to 1C. The modular light 20 includes a light unit 22 and a lighting technology module 24. The light unit 22 includes a light element 22.2 and an optical element 22.4. The light element 22.2 is a light source that emits light and could be, e.g., LED, OLED, FLED, FO, remote phosphor light, fluorescent light bulbs, incandescent light bulb, etc. The optical element 22.4 distributes light emitted by the light element 22.2 and could be, e.g., lenses, diffusers, lamp shades, lamp sconces, lamp bodies, mirrors, etc.

The light unit 22 may further include a light unit mechanical/electrical interface 26 that attaches or mounts the light unit 22 to a mounting base unit (e.g., housing or fixture) 29 having a mating light unit interface 29.1 that mates with and is removably coupled to the light unit mechanical/electrical interface 26. The mounting base unit 29 may be mounted on or embedded in the vehicle wall or ceiling, such as the aircraft wall 5. As defined herein, “removably coupled” means using a plug or card edge connector that mates with a corresponding socket or contact in a non-permanent manner.

An exemplary light unit mechanical/electrical interface 26 may have a plug/male connector and socket/female connector configuration, such that the plug 26 is attached to the light unit 22 and the socket 29.1 is attached or mounted on/in the vehicle wall or ceiling. In this configuration, the light unit 22 and the mounting base unit 29 may be connected via connection 21. In other embodiments, the light unit 22 only includes the light element 22.2, and not the optical element 22.4. Optionally, the light unit 22 may be connected to the lighting technology module 24 via connection 23.

Also in FIG. 2, the lighting technology module 24 includes a light driver 24.2 and a light engine 24.4. The light driver 24.2 provides current (or voltage) to drive the light element 22.2. The light driver 24.2 may be, e.g., a microcontroller, and include hardware and software modules necessary to drive the light element 22.2 to produce illumination at some defined level and/or color. For example, the light driver 24.2 could be an LED driver, OLED driver, FLED driver, FO unit driver, remote phosphor light driver, and any other light driver associated with any type of light element 22.2.

The light engine 24.4 includes various lighting technologies that may be used to enhance the lighting experience with the light element 22.2. For example, the light engine 24.4 may include a light intensity and color module that changes the intensity of the light emitted by the light element 22.2 and changes the color of the light emitted by the light element 22.2. The light engine 24.4 may also include a wireless or wired transceiver (e.g., Wi-Fi 11) that receives a control signal from a passenger device so that a passenger may control the modular light 20. The various lighting technologies in the light engine 24.4 may include hardware modules, software modules, or both, that are required for implementing the lighting technologies.

A distinction is made herein regarding both hardware and software between “installed” and “enabled.” Installed means physically present. Enabled means installed and operational. Either hardware or software may in these units may be not installed, installed and not enabled, or installed and enabled. The enabling would typically be done by a manufacturer, distributor, or product representative. There are many ways or means of enabling, including enabling a section in memory or scene that is present in the lighting LRU but not enabled. It could also be enabled by changing the lighting zone within each LRU. Also depending on aircraft type, some features may be enabled or inhibited based on qualification data, type certificate, and performance. For example, some small aircraft may have all scene and software enabled, and large aircraft may only have some/all enabled. Same configurations may apply for BIT/BITE. Due to weight and space considerations, it is more likely that the hardware modules associated with an unselected lighting technology are not installed. On the other hand, it more likely that the software modules for an unselected lighting technology be installed but not enabled, as opposed to simply not enabled. However, due to other cost factors, certain hardware could be installed and not enabled (e.g., white and color LEDs are installed, but color LEDs are not enabled), since the overhead in terms of weight and size is negligible, so that they could be easily enabled in the future.

In various embodiments, the lighting system changes the passenger experience by enabling and/or disabling functions or performance of the modular light units. FAA (Federal Aviation Administration) or other agency approvals of the lighting system can be adjusted from qualification and/or certification data, since there may be different requirements for different types of aircraft. The lighting system allows different scenes, modes, power levels, etc. for different aircraft type, based on different requirements. For instance, for a first type of aircraft, ten scenes/modes may be enabled to meet the requirements; for a second type of aircraft, only eight scenes/modes may be enabled to meet the requirements. Furthermore, the lighting system offers different level of maintenance capabilities or access to BIT/BITE capabilities.

The lighting technology module 24 may include a lighting technology module mechanical/electrical interface 28 that attaches or mounts the lighting technology module 24 to a mating lighting technology module interface 29.2 of the base unit 29 mounted on or in the vehicle wall or ceiling, such as the aircraft wall 5. The lighting technology module mechanical/electrical interface 28 could be attached to the lighting technology module 24 on an inside surface or an outside surface of the vehicle wall. An exemplary lighting technology module mechanical/electrical interface 28 may have a plug and socket configuration, such that the plug (the lighting technology module mechanical/electrical interface 28) is attached to the lighting technology module 24 and the socket (the mating lighting technology module interface 29.2) of the base unit 29 is attached or mounted on the vehicle wall or ceiling.

The modular light 20 also includes a communication module 24.6, and a power converter 24.8. The communication module 24.6 could be a wired or wireless transceiver, so that the modular light 20 may be controlled locally or remotely in the aircraft. By way of an example, the communication module 24.6 could receive a command from a remote controller (e.g., a mobile device or a central controller) to control the light driver 24.2. The power converter 24.8 converts AC power to DC power, or vice versa, to provide power to the light element 22.2. In an embodiment, the communication module 24.6 and the power converter 24.8 may be mounted or embedded in the mounting base unit 29. In another embodiment, the communication module 24.6 and the power converter 24.8 may be components within the lighting technology module 24. The connection lines in FIG. 2 indicate both input and output connections.

While FIG. 2 illustrates one modular light 20, modular light groups may also be used in the multi-technology lighting system. A modular light group may include a plurality of light units and the plurality of the same or different types of lighting technology modules associated with the respective same or different plurality of light units. The plurality of light units may include various types of light elements. Furthermore, there may be one lighting technology module per light unit. Alternatively, there may be one lighting technology module per type of light units.

In another embodiment, there may be only one group lighting technology module associated with the plurality of light units. In this configuration, the group lighting technology module includes the plurality of light drivers and light engines associated with the plurality of light units.

Advantageously, the modular light 20 may be qualified and certified for vehicle use. For example, a small number (e.g., four) of light units (LED, OLED, FO, remote phosphor light) and their appertaining lighting technology modules, can be qualified and certified for vehicle use, pursuant to a specific certification authority, along with various optical elements, such as lamp shades, lamp bodies, lenses, and other mechanisms to display and distribute light. These could allow a much larger number of different combinations of modular light units to be used in any sort of context on the vehicle (based on class, location characteristics, etc.). Advantageously, since the modular lights have already been certified individually, new lighting designs that are built up from these modular lights do not require further certification, permitting a large level of flexibility in design.

Furthermore, the light unit 22 and the lighting technology module 24 of the modular light 20, along with the mounting base unit 29 may be mounted on the surface of the aircraft wall 5 using the light unit mechanical/electrical interface 26 and lighting technology module mechanical/electrical interface 28, respectively. This configuration allows for easy retrofitting of existing aircraft, so that the existing infrastructure within the aircraft wall 5 may fitted with the multi-technology lighting architecture with no change or minimal change. In this configuration, the mounting base unit 29 is considered to be a part of the modular light 20 itself.

Alternatively, the modular light 20, or components of the modular light 20 (e.g., the lighting technology module 24, the lighting technology mechanical/electrical interface 28, and/or the light unit mechanical/electrical interface 26) may be buried or embedded within the aircraft wall 5. In this configuration, the mounting base unit 29 is more a part of the aircraft than the modular light 20. This configuration allows aircraft manufacturers and other OEMs (original equipment manufacturers) to build and embed all or a portion of the infrastructure of the lighting architecture directly inside the aircraft wall 5 in new aircraft.

The following is a detailed discussion of the operation of the lighting engine 24.4, according to an embodiment. Lighting in aircraft comes in many colors, scenes, intensity levels, etc., from general cabin lighting to area, zone or suite specific feature/specialty lighting. There is a need to offer low end entry level solutions that may be “white only” with simple on/off or discrete set point control up to “full color” systems with 0-100% dimming capability. Traditionally, this has been supported through separate hardware and product offerings as well as separate qualification/certification and installation and removal efforts. To offer flexibility and configurability in an aircraft lighting system, as an example, the lighting engine 24.4 may include a “full-color” RGBW hardware module that may be a 28 VDC based solution with an optional external or internal 115 VAC, 400 Hz power supply. The lighting engine 24.4 may also include software “plug-in,” which is downloadable or enabling software that transforms a simple “white only” solution to “full color” simply by downloading new software.

In the current embodiment, the light engine 24.4 has installed therein full RGBW colors and full intensity adjustable hardware with a default state of “white only” and on/off or off/night/dim medium/bright control only, with embedded operational software and a memory map that supports downloadable software upgrades that can “turn-on” or enable full color, dimming, BIT (built-in testing) and other features. The software can be loaded to the light engine 24.4 wirelessly via Wi-Fi or through hardwired connections such as through EIA/TIA RS-485 or a local port. This “loadable ops” software upgrade can be done in the manufacturing factory as well as in the installed location within the aircraft.

The benefits of this system are that one hardware product can be qualified and/or certified with the strictest hardware and modes requirement, be produced in high volume, and installed and then enabled in an entry level “white only” simple on/off mode. Then when the customer can afford or wishes to explore more capability such as WWR (white-white-red)/WWA (white-white-amber), RWB (red-white-blue) and full RGBW (red-green-blue-white), the customer can download the new operational code “in-situ” in the aircraft and avoid costly maintenance, repair, overhaul (MRO) activities. Furthermore, optional hardware modules can be added and/or attached to the initial hardware LRUs that extend the functionality. Additionally, local dip switches and other hardware on the lighting LRU can also be utilized to enable embedded features.

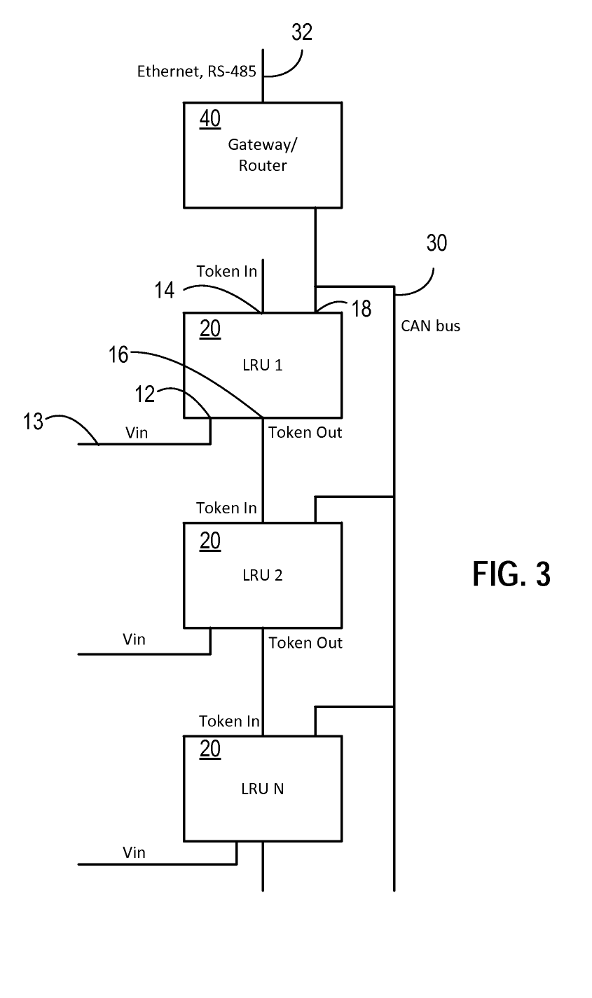

FIG. 3 illustrates one possible architecture for the addressing of a plurality of modular lights 20, identified as line replaceable units (LRU1-N) over CAN bus (controller area network bus). Each of the modular lights 20 has a power input 12 to which a power line 13 is connected, a token input 14, a token output 16, and a communication input/output (I/O) line 18. The token input 14 of a first unit LRU1 is left disconnected (floating or configured to some predefined state). The token output 16 of the first unit LRU1 is connected to the token input 14 of the next unit LRU2 in sequence. The units 10 (LRU1-N) are thus daisy chained with respect to the token lines, but are connected in parallel with the communication I/O line 18. The exemplary CAN bus communication line 30 is preferably connected to a CAN bus gateway/router 40 that may interface the units and CAN bus 30 with another network communication line 32, such as Ethernet, RS-485, etc.

According to an embodiment, the addressing of the modular lights 20 can take place as follows. As a default, the token input line 14 can be set high from the factory. Token outputs 16 are preferably set to a low state in the factory. However, to ensure that all token outputs 16 are actually in a low state, a first broadcast CAN bus message can be sent out by the CAN bus gateway router 40: “set token out low”, which causes the first unit LRU1 to pull the token output 16 low. Since the remaining units (LRU2-N) are daisy chained from the token output 16 of the first unit LRU1, the token inputs 14 of the remaining units (LRU2-N) are pulled low. Next, a second broadcast message is sent out: “the unit with token input as high—set address to ‘1’”; the unit LRU1's address is set to “1”. Since the first unit LRU1 does not have a connection at its token input 14, the token input 14 is still high when the second broadcast message is sent. Thus, the first unit LRU1 sets its address to “1” in response to the second broadcast message. Then, the first unit LRU1 sends an acknowledgement (ACK) on the CAN bus 30 and changes the state of its token out 16 to high. The second unit LRU2 now sets its address to “2”, and this process is repeated until the last unit LRUN has its address set. Preferably a ten second timeout can be provided for the last node, unless the total raw count of LRUs was loaded (in which case the system would know how many LRUs to expect and to initialize in the system).

Furthermore, the lighting architecture disclosed herein may take advantage of different protocols used in aircraft. For example, the lighting control architecture may take advantage of different communication buses in the aircraft, e.g., RS-485 for general cabin lighting and CAN bus for galley lighting. The lighting architecture may also have different power supply configurations.

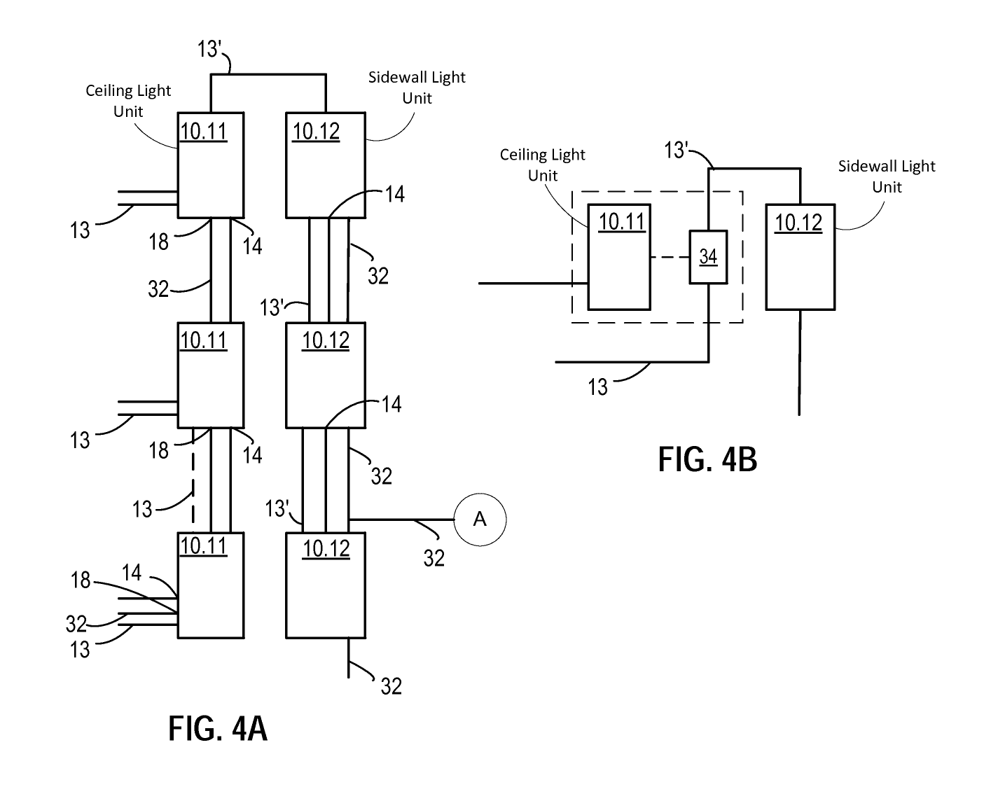

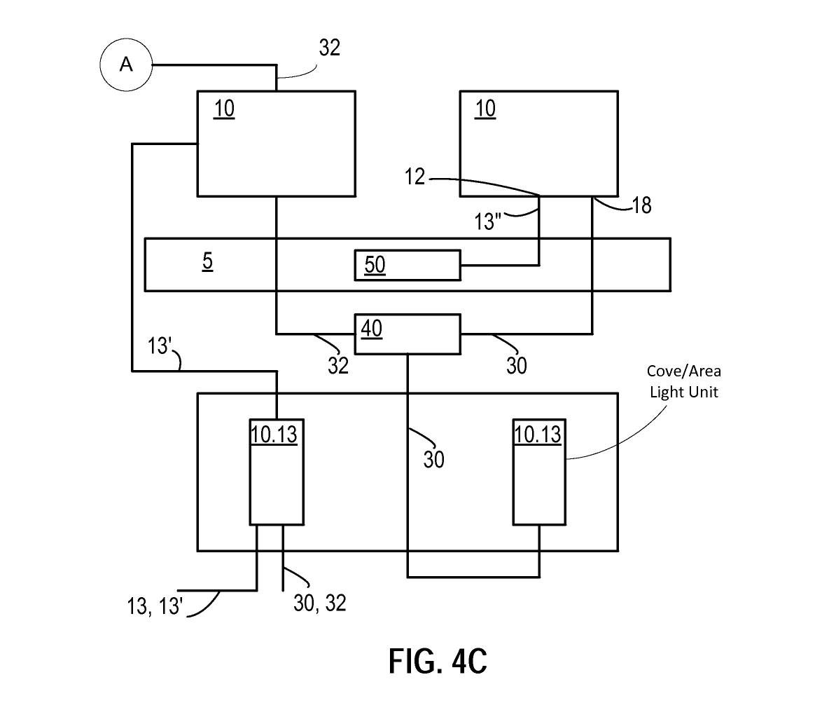

FIG. 4A is a block diagram illustrating an exemplary configuration of general cabin light units, according to an embodiment. As shown, three ceiling light units 10.11 are connected together, and the ceiling light units 10.11 is a type of general cabin light unit 10.1. The bottom ceiling light unit 10.11 has a power line (AC) input 13 (e.g., 115VAC at 400 Hz), a communication input 18 to which a network communication line 32 is connected, and a token input 14. The lower ceiling light unit 10.11 is connected with the middle ceiling light unit 10.11 via a communications line 18 and a token line going to a token input 14. Optionally, the power line 13 can be provided to the middle ceiling light unit 10.11 from the lower light unit—or, the power can be provided from an external source. The topmost ceiling light unit 10.11 is similarly connected in series with the lower and middle ceiling light units 10.11.

The three sidewall light units 10.12, also a type of general cabin light unit 10.1, take their power via a DC feed/power line 13′ from the ceiling light units 10.11. The three sidewall light units 10.12 are connected to each other in series via a communication line 32 and the DC feed 13′. The communication line 32 is connected to the outside at the bottom sidewall light unit 10.12. In FIG. 4A, the general cabin light units may use excess power in the aircraft or may draw power from a power supply elsewhere in an aircraft.

FIG. 4B is a block diagram illustrating another exemplary configuration of general cabin light units, according to another embodiment. As can be seen, a ceiling light unit 10.11 is electrically connected to a DC power converter 34 by a galvanic separation, such as a transformer or other means to provide an “air gap” between primary (e.g., 115VAC) and secondary voltages (e.g. 28VDC). The ceiling light unit 10.11 and the DC power converter 34 are isolated from other cabin light units, e.g., sidewall light unit 10.12. The separate and isolated DC power converter 34 converts 115 VAC at 400 Hz from the power line 13 into 28 VDC (i.e., DC feed 13′) for use by further units. The DC power converter 34 is connected to a sidewall light 10.12 via the DC feed 13′. Furthermore, the ceiling light unit 10.11 and the sidewall light unit 10.12 could, for example, connect with other DC wash lights or other general cabin light units. In other embodiments, the ceiling light unit 10.11 could be directly connected to the DC power converter 34, without the galvanic separation.

FIG. 4C is a block diagram illustrating an exemplary configuration of feature light units 10 and cove/area lights 10.13, according to an embodiment. Point A is a network connection 32 RS-485 that connects the bottom sidewall light unit 10.12 (FIG. 4A) to a feature light unit 10. The communication line 32 is further routed to a gateway/router 40 and communication signals are distributed over a CAN bus line 30 to another feature light unit 10 and a cove/area light unit 10.13. Although the cove/area light 10.13 is shown, other light units, such as general cabin light units 10.1, galley light units, lavatory light units, etc., could be used. The left cove/area light 10.13 may have a further connection to a communication bus (30 or 32) and power line (AC power line 13 or DC feed 13′).

FIG. 4C illustrates two options of providing power to the feature lights 10. In the first option, the DC feed 13′ provides excess power (i.e., power not consumed by the general cabin lights in the aircraft) to the feature light units 10, since the feature light units 10 are in addition (e.g., above and beyond) the general cabin lights in the aircraft. Thus, the first option (the DC feed 13′) allow for efficient use of excess power when retrofitting existing aircraft, without modification to the existing lighting power infrastructure.

In a second option, a power supply 50, which is separate from the main power supply of the aircraft, may be used to supply power to the feature light units 10 instead of the excess power used in the first option. The top rightmost light unit 10 is provided with a power line 13″ at a power input 12 that has been generated by the power supply 50. The power supply 50 may be mounted on the surface of the aircraft wall 5, or may be partially or fully embedded within the aircraft wall 5. This second option allows OEMs to build the infrastructure of the lighting architecture directly inside the aircraft wall 5 in new aircraft.

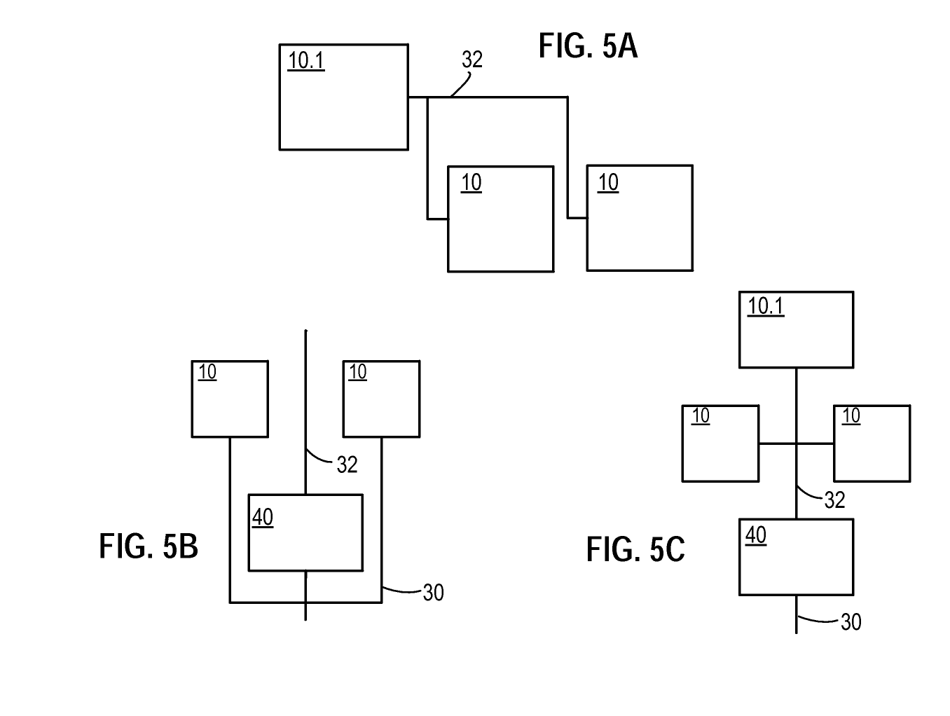

FIGS. 5A to 5C illustrate various communication configurations of the multi-technology lighting architecture. In FIG. 5A, it can be seen that general cabin light unit 10.1 connects to two feature light units 10 over an RS-485 network communication line 32. In FIG. 5B, an originating RS-485 communication line 32 provides the communications to the feature light units 10 after going through the galley gateway/router 40. Alternatively, FIG. 5C shows that the RS-485 network communication line 32 can interconnect the general cabin light units 10.1 with the feature light units 10 that originates from a CAN bus network 30 and is passed through a galley gateway/router 40.

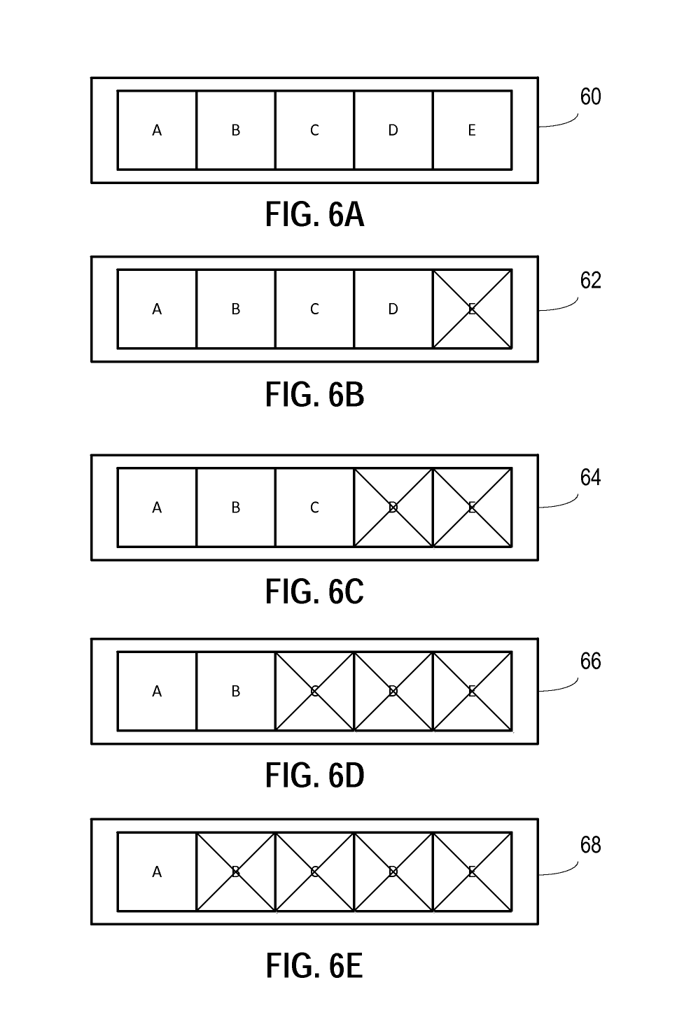

FIG. 6A is a block diagram illustrating a modular light unit 60 having five lighting technology modules A, B, C, D, and E installed and/or enabled. The module light unit 60 may be an exemplary light unit used in the super first class section. The modular light unit 60 may be a feature light unit 10, a general cabin light unit 10.1, a galley light unit, or a lavatory light unit. Each of the five lighting technology modules A, B, C, D, and D may be the lighting technology module 24 as illustrated in FIG. 2. Since all five lighting technology modules A, B, C, D, and E are enabled, the modular light unit 60 offers a more sophisticated lighting control and more luxurious lighting experience in the super first class section.

FIG. 6B is a block diagram illustrating a modular light unit 62 having four lighting technology modules A, B, C, and D installed and/or enabled, where the fifth lighting technology module E is disabled or not installed. In other words, the modular light unit 62 of FIG. 6B is same as the modular light unit 60 in FIG. 6A, except the fifth lighting technology module D is disabled. The modular light unit 62 in FIG. 6B may be an exemplary light unit used in a first class section of the aircraft, where the lighting control may be of lesser-enabled capability than in the super first class section, because only four of the five lighting technology modules are enabled. By way of example, light technology module E might be a Wi-Fi interface that permits a passenger some level of control over the lighting. This feature could be disabled for first class passengers.

FIG. 6C is a block diagram illustrating a modular light unit 64 having three lighting technology modules A, B, and C installed and/or enabled, where the other two lighting technology modules D and E are disabled or not installed. The modular light unit 64 FIG. 6C may be an exemplary light unit used in a business class section of the aircraft, where the lighting control is of lesser-enabled capability than in the first class section.

FIG. 6D is a block diagram illustrating a modular light unit 66 having two lighting technology modules A and B installed and/or enabled, where the other three lighting technology modules C, D and E are disabled or not installed. The modular light unit 66 FIG. 6D may be an exemplary light unit used in an enhanced economy class section of the aircraft, where the lighting control is of lesser-enabled capability than in the business class section.

FIG. 6E is a block diagram illustrating a modular light unit 68 having only one lighting technology module A installed and/or enabled, where the other four lighting technology modules B, C, D and E are disabled or not installed. The modular light unit 68 FIG. 6E may be an exemplary light unit used in an economy class section of the aircraft, where the lighting control is of lesser-enabled capability than in the enhanced economy class section.

When viewed together, FIGS. 6A to 6E illustrate the modularity of the lighting architecture. For example, in each class section of the aircraft, all five lighting technology modules A, B, C, D, and E may be installed. Then, for each class, the OEMs or airlines have the option to enable or disable whichever light lighting technology modules they want. In this case, the lighting technology modules may be enabled/disable via software or hardware. Alternatively, the OEMs may decide to only install one or some of the lighting technology modules in each class. Accordingly, the modularity of the lighting architecture provides OEMs and airlines greater flexibility in choosing and creating the lighting experience they want to provide to the passengers. Since the modular components themselves have been certified, systems made up from them are already certified (or require minimal additional certification), and thus a great deal of flexibility for lighting design and reconfiguration can be realized.

In various embodiments, the multi-technology lighting system may also provide a load shedding power management module. The load shedding power management module could be a software module that prioritizes power loading by class sections within the aircraft. The load shedding power management module could be a standalone module or could feed into the main power management system in the aircraft. It could also be a priority setting in the LRU software or hardware. For instance, feature lights in the economy section (e.g., zone 5) may be of a low priority, where feature light in super first class section (e.g., zone 1) may be of a high priority. It could also relate to all other lighting application in the aircraft. It would be a scene embedded in the LRU.

The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media is readable by the computer, stored in the memory, and executed by the processor.

All references, including publications, patent applications, and patents, cited herein are hereby incorporated by reference to the same extent as if each reference were individually and specifically indicated as incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The embodiments herein may be described in terms of functional block components and various processing steps. Such functional blocks may be realized by any number of hardware and/or software components that perform the specified functions. For example, the described embodiments may employ various integrated circuit components, e.g., memory elements, processing elements, logic elements, look-up tables, and the like, which may carry out a variety of functions under the control of one or more microprocessors or other control devices. Similarly, where the elements of the described embodiments are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the embodiments of the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Expressions such as “at least one of,” when preceding a list of elements, modify the entire list of elements and do not modify the individual elements of the list.

The use of the terms “a” and “an” and “the” and similar referents in the context of describing the invention (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein are performable in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

TABLE OF REFERENCE CHARACTERS

| | |
|---|---|
| 5, | aircraft wall |
| 10, | feature light unit |
| 10a, 10b, | |
| 10c, 10d | |
| 10.1 | general cabin light unit |
| 10.11 | ceiling light unit |
| 10.12 | sidewall light unit |
| 10.13 | cove or area light unit |
| 11 | wireless connection |
| 12 | power input |
| 13 | power line (AC) |
| 13′ | power line (DC) option 1 |
| 13″ | power line (DC) option 2 |
| 14 | token input |
| 16 | token output |
| 18 | communication I/O line |
| 20 | modular light |
| 21 | light unit connection to base unit |
| 22 | light unit |
| 23 | light unit connection to lighting technology module |
| 22.2 | light element |
| 22.4 | optical element |
| 24 | lighting technology module |
| 24.2 | light driver |
| 24.4 | light engine |
| 24.6 | communication module |
| 24.8 | power converter |
| 26 | light unit mechanical/electrical interface, plug |
| 28 | light engine mechanical/electrical interface, plug |
| 29 | mounting base unit or fixture |
| 29.1 | light unit interface, socket |
| 29.2 | light engine interface, socket |
| 30 | CAN bus |
| 32 | network, Ethernet, RS-485 |
| 40 | gateway router |
| 50 | power supply |
| 60, 62, | modular light units |
| 64, 66, | |
| 68 | |

What is claimed is:

1. A lighting system comprising:
a base unit;
a first modular light comprising:
a first light unit comprising:
a first light element that emits light; and
a first mechanical, electrical, and control signal physical light unit interface that is removably coupled to a first mating light unit interface on the base unit;
a first lighting technology module that is physically separate from the first light unit, the first lighting technology module comprising:
a first light driver that drives the first light element;
a first light engine that is coupled to the first light driver; and
a first mechanical, electrical, and control signal physical light technology module interface that is removably coupled to a first mating light technology module interface on the base unit.

2. The lighting system of claim 1, in which the first light element comprises a light source selected from the group consisting of a light emitting diode (LED), a flexible LED, an organic light emitting diode (OLED), a fiber optic unit, a remote phosphor light, a fluorescent light bulb, and an incandescent light bulb.

3. The lighting system of claim 1, in which the first mechanical, electrical, and control signal physical light unit interface is a plug, and the first mating light unit interface is a socket.

4. The lighting system of claim 1, in which the first light unit further comprises an optical element.

5. The lighting system of claim 1, in which the first light driver comprises a driver selected from the group consisting of a LED driver, a flexible LED driver, an OLED driver, a fiber optic unit driver, a remote phosphor light driver, a ballast, and a dimming switch.

6. The lighting system of claim 1, in which the first light engine comprises a module selected from the group consisting of a transceiver that receives a control signal from a passenger device, and a light intensity and color module that adjusts an intensity of light emitted by the first light element.

7. The lighting system of claim 6, in which the first light engine has a remote enable switch that is configured to be remotely enabled.

8. The lighting system of claim 1, in which the first mechanical, electrical, and control signal physical light technology module interface comprises a plug, and the first mating light technology module interface comprises a socket.

9. The lighting system of claim 1, further comprising:
a communication module that enables communication between the first lighting technology module and a remote controller; and
a power converter that converts power used by the first modular light.

10. The lighting system of claim 9, in which the power converter converts AC power to DC power.

11. The lighting system of claim 1, in which the base unit and the first lighting technology module are embedded in a wall of a vehicle.

12. The lighting system of claim 1, further comprising:
a second modular light comprising:
a second light unit comprising:
a second light element that emits light; and
a second mechanical, electrical, and control signal physical light unit interface that is removably coupled to a second mating light unit interface on the base unit;
a second lighting technology module that is physically separate from the second light unit, the second lighting technology module comprising:
a second light driver that drives the second light element;
a second light engine that is coupled to the second light driver; and
a second mechanical, electrical, and control signal physical light technology module interface that is removably coupled to a second mating light technology module interface on the base unit;
wherein the first light unit is interchangeable with the second light unit, and the first lighting technology module is interchangeable with the second lighting technology module on the base unit.

13. The lighting system of claim 12, in which the first modular light and the second modular light are connected in series by a communication line and a power line, and the power line receives excess power from a main power supply of a vehicle.

14. The lighting system of claim 12, further comprising a power converter that is connected to the first modular light, wherein the first modular light and the power converter are isolated from the second modular light, and the power converter provides power to the second modular light.

15. The lighting system of claim 12, further comprising a power supply that is separate from a main power supply of a vehicle, wherein the power supply provides power to the first modular light and the second modular light.

16. The lighting system of claim 12, further comprising:
a router;
a first communication line that connects the first modular light to the router; and
a second communication line that connects the second modular light to the router.

17. The lighting system of claim 16, in which the first and second communication lines are RS-485 network connections.

18. The lighting system of claim 16, in which the first and second communication lines are controller area network (CAN) bus lines.

19. The lighting system of claim 12, further comprising:
a gateway that interfaces to two different protocols;
a first communication line that connects the first modular light to the gateway; and
a second communication line that connects the second modular light to the gateway.

20. The lighting system of claim 19, in which the first communication line is a RS-485 network connections, and the second communication line is a CAN bus line.

21. The lighting system of claim 12, in which the first light element is a type of light source that is different from the second light element.

22. The lighting system of claim 12, in which:
the first modular light further comprises a first token input and a first token output;
the second modular light further comprises a second token input and a second token output;
the first token input is either floating or set to a predetermined state; and
the first token output is connected to the second token input.
